(19) United States
(12) Patent Application Publication
(10) Pub. No.: US 2015/0108889 A1
(43) Pub. Date: Apr. 23, 2015

(54) DOOR FOR FURNITURE UNITS AND FURNITURE UNIT COMPRISING SAID DOOR

(71) Applicant: ERNESTOMEDA S.p.A., Montelabbate (IT)

(72) Inventor: Giuseppe Bavuso, Carate Brianza (IT)

(21) Appl. No.: 14/404,390

(22) PCT Filed: Jun. 4, 2013
(86) PCT No.: PCT/IB2013/054593

§ 371 Date: Nov. 26, 2014

(30) Foreign Application Priority Data
Jun. 5, 2012 (IT) BO2012A000305

(51) Int. Cl. E06B 7/02; A47B 96/00

(52) U.S. Cl. CPC E06B 7/02; A47B 96/00; E06B 2007/026
USPC 312/294; 428/138

(57) ABSTRACT

A furniture unit comprises a containment element defining a receiving compartment and a door equipped with a first panel defining an outer face of the door, a second panel facing the first panel and defining an inner face of the door, and an outer frame interposed between the first panel and the second panel and connected to them. The door comprises within it an air vent duct which extends between a first opening made in the outer frame and a second opening made in the second panel.

### TECHNICAL FIELD

This invention relates to a door for furniture units, in particular kitchen furniture units, and a furniture unit, for example, a wall cabinet, a chest of drawers and floor-standing cupboards and cabinets, comprising the door.

This invention applies in particular to the interior decoration and design sector, in particular to the production of high-quality kitchen furniture.

### BACKGROUND ART

One of the problems most strongly felt in the interior decoration sector, in particular the furniture sector, is that of aerating the compartments inside the furniture in order to prevent bad smells and damp caused by stagnating fluids.

These problems are particularly common in the kitchen owing to the presence of a wide range of food odours and the frequent changes in humidity inside the room resulting from the use of cooking hobs and ovens.

In the prior art, this problem has been solved by shaping the furniture doors in such a way as to leave a small gap between the door and the body of a furniture unit even when the door is closed, thus facilitating air circulation.

Disadvantageously, this solution, besides being in some cases unattractive in appearance, does not enable the quality of the air circulating inside a compartment to be controlled and, moreover, allows dirt, insects and, in some cases, liquids, to find their way into the furniture.

### AIM OF THE INVENTION

The basic technical purpose of this invention is to provide a door for furniture units and a furniture unit capable of overcoming the above mentioned problems.

More specifically, the invention has for an aim to provide a door for furniture units and a furniture unit which allow the furniture compartment to be well aerated while maintaining a high aesthetic appeal.

Another aim of the invention is to provide a door for furniture units which allows the compartment inside the furniture unit to be effectively closed.

The technical purpose and aims specified are substantially achieved by a door for furniture units comprising the technical features described in one or more of the appended claims.

### BRIEF DESCRIPTION OF THE DRAWINGS

Further features and advantages of the invention are more apparent from the non-limiting description which follows of a preferred, non-limiting embodiment of a door for furniture units as illustrated in the accompanying drawings, in which:

FIG. 1 is a front perspective view, with some parts in cross-section, of a door for furniture units according to this invention;

FIG. 1a is a scaled-up view of a detail from FIG. 1;

FIG. 2 is a rear perspective view of a second embodiment of the door for furniture units according to the invention, with some parts cut away in order to better illustrate others;

FIGS. 2a and 2b are scaled-up views of respective details of the door of FIG. 2;

FIG. 3 is perspective view of a furniture unit according to the invention.

### DETAILED DESCRIPTION OF PREFERRED EMBODIMENTS OF THE INVENTION

With reference to the accompanying drawings, the numeral 1 denotes a door for furniture units 100 according to this invention.

The door 1 is a door for furniture units, that is to say, a movable part which can be gripped by a user in order to move it (tilting, slidable, side-hung, drawer, and so on) between a first and a second position to open or close a compartment inside the furniture unit 100. In other words, the door 1 according to the invention can be used on any type of furniture unit 100.

The door 1 comprises a first face 1a and a second face 1b which are substantially parallel to each other and defining, in use, an outer face and an inner face of the compartment 102 of the furniture unit 100. The door 1 also comprises a plurality of side (peripheral) faces 1c interposed between the first face 1a and the second face 1b to space them apart.

In light of this, the door 1 is not made as one part (that is, it is not a single component) but comprises a plurality of components assembled to each other, allowing greater production flexibility.

Preferably, the door 1 comprises a first panel 2 defining (in use) the outer face of the door 1 (and hence the first face 1a) and a second panel 3 facing the first panel 2 and defining (in use) the inner face of the compartment (and hence the second face 1b).

The first panel 2 and the second panel 3 are spaced from each other by an outer frame 4 interposed between them in order to keep them apart.

Thus, both the first panel 2 and the second panel 3 abut against the outer frame 4 to form a sandwich structure.

Preferably, the panels 2, 3 are connected to the frame 4 irremovably (for example by an adhesive), that is to say, their “separation” means it is impossible for the door 1 to be re-used.

Alternatively, however, the panels and the frame might be connected to each other removably, using reversible connecting means.

It should be noted that the first panel 2 may be of any type or material, depending on the decor and furniture setting of the room where the door 1 is installed.

Preferably, the frame 4 has an annular structure, that is to say, it is provided with a plurality of segments connected to each other in succession to form a closed (polygonal) perimeter.

in the embodiment illustrated, the frame 4 has four segments 4a defining a quadrilateral structure.

In this embodiment, the outer frame 4 comprises a plurality of extruded sections (segments 4a), made of a metallic material.

Alternatively, however, the frame might be made of other materials, such as wood, plastic or polymers.

it should be noted that the peripheral portions of the frame 4 partly define the edges of the first face 1a and of the second face 1b.

The frame 4 also defines the side faces 1c of the door 1,

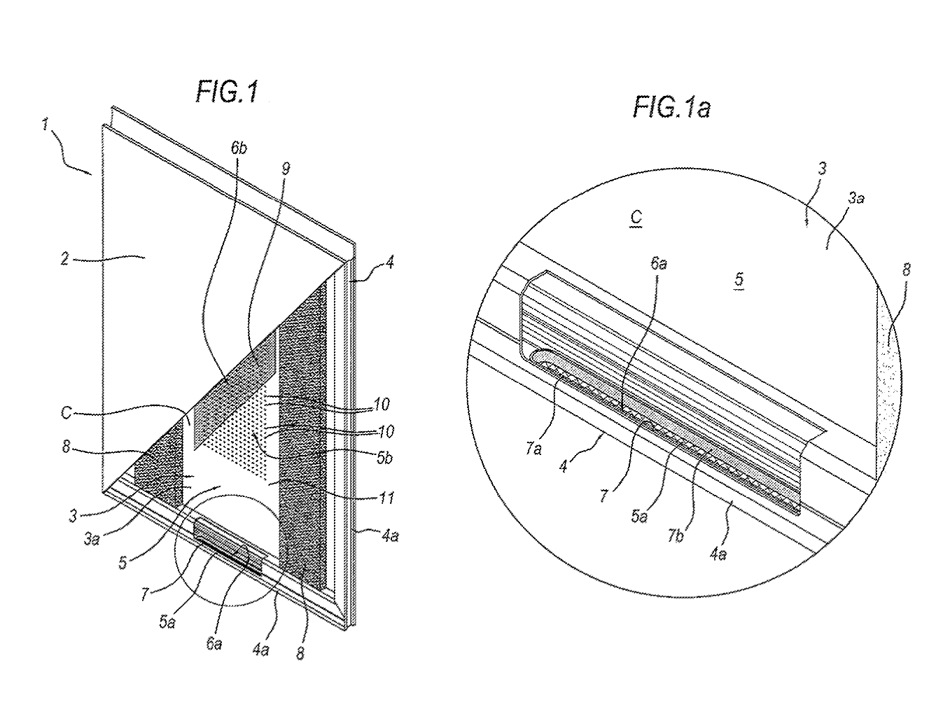

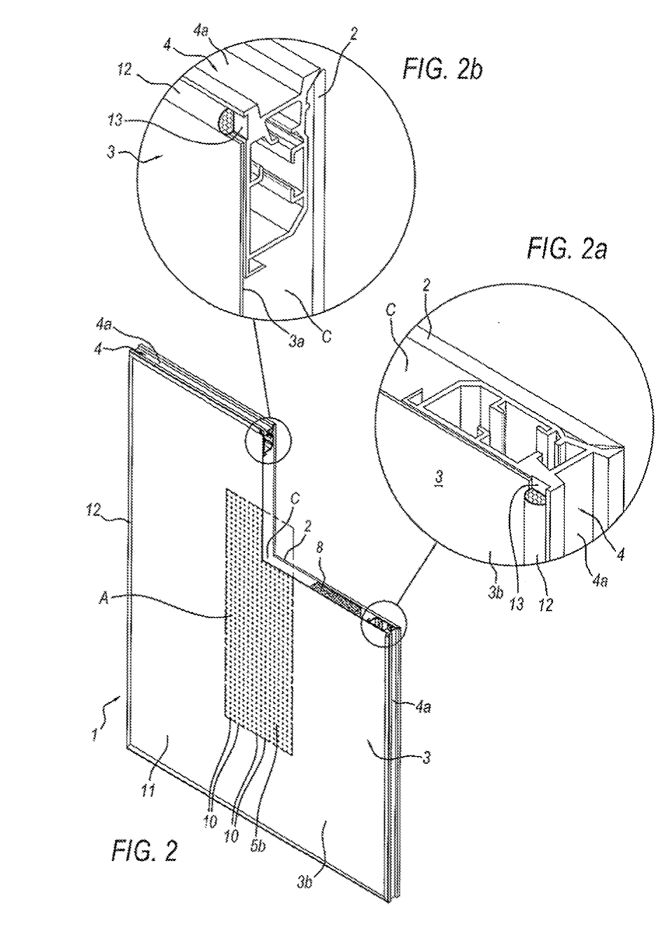

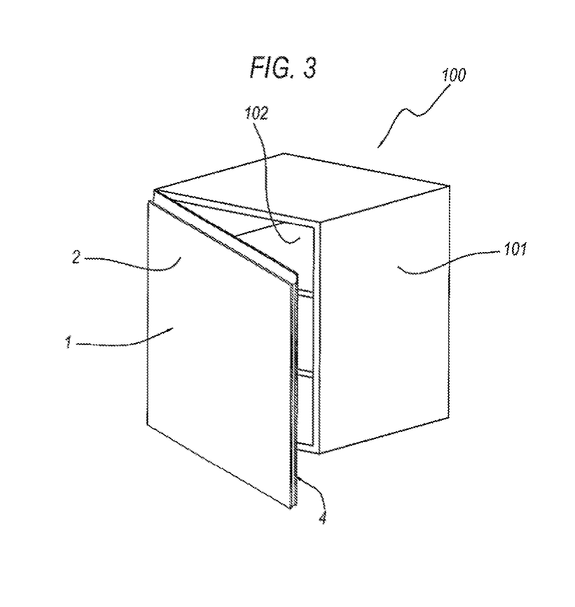

It should be noted that the door may also comprise a handle, which may be connected to the frame or defined by a groove in the frame (FIG. 1) or integrated (recessed) in the panel 2 (this solution not being illustrated).

According to the invention, the door 1 comprises within it an air vent duct 5 which extends between a first opening 5a made in the outer frame 4 or in the first panel 2 and a second opening 5b made in the second panel 3.

Advantageously, that way, air can circulate between the inside and the outside of the furniture unit 100 without having to provide a gap at the door bumper.

it should be noted that a chamber “C” is defined inside the door 1 between the first panel 2 and the second panel 3. The chamber “C” is laterally delimited by the outer frame 4.

in other words, the door 1 is a box-like body whose walls are defined by the first panel 2, the second panel 3 and the frame 4.

The chamber “C” is accessible from the first opening 5a and from the second opening 5b, thus defining the air vent duct 5.

Preferably, the door 1 has a block (or piece) of filler material 8 located inside the chamber “C” to decrease the resonating effect inside the door 1.

In other words, the block of filler material 8 reduces the “empty” space inside the door 1 (that is, it reduces the unoccupied space), thereby decreasing the resonating effect which would be created (as in a soundbox) every time the door 1 is closed.

in this regard, the block of filler material 8 is defined by at least one piece (preferably two blocks) of expanded polymer.

Also, the filler material is light in weight and has heat resistance properties such that it does not undergo phase changes.

In the embodiment illustrated, the filler material is an expanded material, for example a styrene, polystyrene or the like.

Preferably, the block of filler material 8 is of sound absorbent type.

Preferably, the first opening 5a is made in the outer frame 4 so it is hidden from the users view.

More specifically, the first opening 5a is made on one side of the frame 4, corresponding to a perimeter face 1c of the door 1.

In other words, the first opening 5a and the second opening 5b (made on the second panel 3) lie in planes which are transversal (preferably at right angles) to each other.

Thus, the vent duct 5 is at least partly in the shape of an L.

Advantageously, therefore, the door 1 can be installed in such a way that the first opening 5a is located on a side which is not visible to the user.

In other words, in doors 1 mounted on a wall cabinet, the opening 5a is made in the top segment 4a (facing the ceiling) of the frame 4. In doors 1 mounted on floor-standing cabinets, the opening 5a is made in the bottom segment 4a (facing the floor) of the frame 4.

In order to allow the circulation only of filtered air, the door 1 comprises a first filter 6a and a second filter 6b associated with the first opening 5a and with the second opening 5b, respectively,

Advantageously, therefore, the compartment inside the furniture unit 100 remains free of dust or insects which would otherwise find their way into it and which would be difficult to remove without clearing the furniture unit 100 of all its contents, a troublesome (and time-consuming) task.

Preferably, the first filter comprises a wire or plastic netting 7 located at the first opening 5a of the air vent duct 5.

The netting 7 is defined by a very fine mesh, preferably having a carrying capacity of between 22% and 35%, and more preferably, around 28%, of the surface occupied by the selfsame netting 7.

Preferably, the netting 7 has a concave profile 7a such that it can be inserted into the first opening 5a and provided, at the ends of it, with a contact portion 7b in abutment against the first opening 5a.

In other words, the first opening 5a runs through the segment 4a of the frame 4 and the netting 7 with the concave profile passes through the thickness of that segment and its contact portion 7b comes into abutment with an inside face of the frame 4.

Preferably, the contact portion 7b is deformable to make it easier not only to fit but also to replace.

In the embodiment illustrated, the first opening 5a (and hence the first filter 6a) has an elongate shape extending in the same direction as the respective segment 4a of the frame 4.

The second filter 6b, too, might be made by applying a netting to the second opening 5b.

Preferably, however, the second filter 6b comprises a membrane 9 made of semi-permeable material and abutting against the second panel 3 to occlude the second opening 5b.

The term “semi-permeable” means that the properties of the membrane are such as to selectively allow some types of molecules, and not others, to pass through it.

More specifically, the membrane 9 is permeable to gases but not to liquids so as to allow the circulation of dry air inside the furniture unit 100.

Preferably, the membrane 9 made of semi-permeable material is defined by at least one layer of non-woven fabric.

It should be noted that the membrane 9 abuts against a face 3a of the second panel 3 on the inside of the chamber “C”, in such a way as to be less obtrusive in appearance.

Preferably, the membrane 9 is glued to the face 3a of the second panel 3 so that it is easy, quick and economical to apply.

In the preferred embodiment, the second panel 3 is provided with a plurality of through holes 10, which together (that is, in their entirety) define the second opening 5b of the air vent duct 5.

That way, advantageously, the door allows diffused aeration without detracting either from aesthetic appearance or structural strength.

Moreover, the provision of a plurality of small holes instead of a single larger opening makes it possible to hide from view the second filter 6b (more specifically, the membrane 9) in abutment inside the chamber “C”.

In the preferred embodiment, the second panel 3 is at east partly defined by a plate 11 provided with a plurality of through holes 10.

it should be noted that the through holes are preferably distributed uniformly over a central portion of the plate 11.

in the embodiment illustrated, the through holes 10 define an area “A” having a quadrilateral shape.

In any case, depending on aesthetic/functional requirements, the through holes 10 might be distributed in such a way as to occupy sections of a different shape, either polygonal or irregular.

Preferably, in order to guarantee that only air circulates in the air vent duct 5, the door 1 comprises an outer seal 12 located on its inner face 1b.

More precisely, the seal 12 runs in a loop round the periphery of the second face 1b. The seal 12 may be associated with the second panel 3 (at the face 3b corresponding to the inner face of the door 1) or with the frame 4.

Thus, the connection between the door 1 and the containment element 101 of the furniture unit 100 is hermetically sealed.

Advantageously, this prevents not only the entry of dust or dirt in the compartment 102 of the furniture unit 100, but also the passage of liquids that might drip down along the door and reduce its functionality (for example by soaking the membrane 9).

Preferably, the seal 12 runs all the way round the second panel 3 in all the zones which, in the closed configuration, are in contact with the furniture unit (bumper).

Preferably, the frame 4 comprises an outer groove 13 (surrounding the second panel 3 on its face 3b) defining a housing for receiving the seal 12.

The groove 13 may be made in the frame 4 or defined in the space between the second panel 3 and the frame 4 itself when the two are coupled to each other.

The seal 12 may be made of rubber, of a polymeric material, of a rubber-coated spongy material or the like (any type of deformable material capable of creating a seal can be used).

Preferably, to facilitate fitting and replacement. if necessary, the seal has an adhesive surface for contact with the second panel 3 or with the frame 4 (in particular, with the groove 13).

The invention achieves the proposed aims and brings significant advantages.

Indeed, the presence of an air vent duct to allow the passage of air between the inside and the outside of the furniture unit through the door eliminates the need to leave a gap at the bumper which, besides being unattractive in appearance, is also not very functional.

The use of filtering elements at the openings of the duct improves the quality of the air exchanged with the outside.

Further, the use of the outer seal guarantees that when the door is in the closed position, only filtered air reaches the compartment in the furniture unit, thus considerably improving the quality of the air inside the compartment.

Furthermore, the application of a non-woven fabric to the inner panel prevents liquids from passing through to the inner side of the door and allows only gases (air) to pass through.

1. A door for furniture units, comprising
a first panel at least partly defining an outer face of the door;
a second panel facing the first panel and at least partly defining an inner face of the door;
an outer frame interposed between the first panel and the second panel and connected to them, wherein it comprises within it an air vent duct which extends between a first opening made in the outer frame and a second opening made in the second panel.

2. A door according to claim 1, wherein it comprises a first filter and a second filter respectively associated with the first opening and with the second opening to allow the circulation only of filtered air inside the air vent duct.

3. A door according to claim 2, wherein the first filter comprises a wire or plastic netting located at the first opening of the air vent duct.

4. A door according to claim 2, wherein the second filter comprises a membrane made of semi-permeable material and abutting against the second panel to occlude the second opening; the membrane being permeable to gases but not to liquids to allow the circulation of dry air inside the furniture unit.

5. A door according to claim 4, wherein the membrane made of semi-permeable material is defined by at least one layer of non-woven fabric.

6. A door according to claim 1, wherein the second panel comprises a plurality of through holes defining the second opening.

7. A door according to claim 1, wherein the second panel is at least partly defined by a plate provided with a plurality of through holes; the through holes defining the second opening of the air vent duct.

8. A door according to claim 1, wherein it comprises an outer seal located on the edge of the inner face to allow a sealed connection between the door and the furniture unit when the door is in its closed position.

9. A door according to claim 1, wherein between the first panel and the second panel is a chamber which is accessible from the first opening and from the second opening and which at least partly defines the air vent duct.

10. A door according to claim 9, wherein comprises at least one block of filler material located inside the chamber to decrease the resonating effect inside the door.

11. A furniture unit, comprising:
a containment element defining a receiving compartment;
a door according to any of the preceding claims, associated with the containment element in such a way as to be able to move between an open position, allowing unobstructed access to the compartment, and a closed position, where it at least partly obstructs the compartment.
